(19) United States
(12) Patent Application Publication
(10) Pub. No.: US 2017/0201685 A1
(43) Pub. Date: Jul. 13, 2017

(54) System and method for creating and placing a collection of photo products on a surface

(71) Applicant: Shutterfly, Inc., Redwood City, CA (US)

(72) Inventor: Syed Saleem Javid Brahmanapalli, Fremont, CA (US)

(21) Appl. No.: 15/234,399

(22) Filed: Aug. 11, 2016

Related U.S. Application Data
(60) Provisional application No. 62/277,836, filed on Jan. 12, 2016.

(51) Int. Cl. H04N 5/232; A47G 1/16; H04N 7/18; G06T 7/00; G06T 7/60

(52) U.S. Cl. CPC H04N 5/23293; G06T 7/004; G06T 7/602; H04N 7/183; A47G 1/16; G06T 2207/10004; G06T 2210/04

(57) ABSTRACT

System and method are disclosed for decorating a surface with a collection of personalized photo products. The disclosed method assists designers to choose photo product types, to pick photos for the photo products, to create the photo products, and to place the multiple photo products on the surface. Designers can preview the personalized photo products in correct proportions in the intended environment before the photo products are manufactured.

### TECHNICAL FIELD

This application relates to utilization of digital images, and more specifically, to creation and display of photo products.

### BACKGROUND OF THE INVENTION

Digital images can be stored in user's computers and viewed on electronic display devices. The proliferation of mobile devices such as camera phones and tablet computers has enabled an increasing number of users to take pictures, share photos, post photos online, and create personalized photo products or projects.

Users can upload digital images to a central network location provided by image service providers such as Shutterfly, Inc. The image service providers can enable users to store, organize, manage, edit, enhance, and share digital images at the central network location using a web browser or other software applications. A user can also design and personalize image-based products, and order these products from the image service provider. Examples of the image-based products include image prints, photo books, photo calendars, photo greeting cards, holiday cards, photo stationeries, photo mugs, and photo T-shirts, which incorporate image content provided by the user or the image service provider.

Many image-based products can be displayed on walls for decorations at home or in a business or commercial surrounding. These products can include framed photo prints, posters, calendars, banners, fabrics, pictures printed on canvas, pictures printed on a scroll, etc. Several image-based products are often placed in a group to achieve desirable decorative effects.

Creating personalized image products, however, can take considerable amount of time and effort. Designing multiple photo products for decorating a wall takes extra effort. Designers not only have to pick the right photos and the desirable photo products; they also have to consider the dimensions and geometries of the available area on a wall, the sizes of the photo products, and the overall visual effects of the photo products as a group and compatible with the environment.

There is therefore a need for convenient methods and tools to assist designers to create personalized photo products for the purpose of displaying them in a specific environment.

### SUMMARY OF THE INVENTION

System and method are disclosed for decorating a surface with a group of personalized photo products. The disclosed method assists designers to choose photo product types, to pick images for the photo products, to create the photo products, and to place the photo products on a surface. Designers can preview the personalized photo products in correct proportions in the intended display environment before the photo products are manufactured.

In one general aspect, the present invention relates to a method for automatically creating design for a collection of photo products in a display area, which includes: capturing an image of a display area and an anchor on a wall by a first computer device, wherein the anchor has a known dimension; automatically identifying the anchor on the wall; automatically calculating dimensions of the display area using the known dimension of the anchor and relative dimensions of the display area and the anchor in the image on the first computer device; automatically suggesting a collection of photo products to be placed in the display area based on the dimensions of the display area and sizes of the photo products; and displaying the collection of photo products in the display area on the wall on the first computer device.

Implementations of the system may include one or more of the following. The first computer device can retrieve the known dimension from a computer storage in response to the step of identifying the anchor on the wall. The known dimension of the anchor can be received from a user by the first computer device. The anchor can define location of the display area on the wall. The method can further include displaying a virtual border around the display area on the first computer device, wherein the collection of photo products is displayed within the virtual border on the first computer device. The method can further include automatically suggesting types for the photo products to be placed in the display area based on the dimensions of the display area and sizes of the photo products. The types of the photo products to be placed in the display area can be automatically selected in part based on a color or a texture of the wall. The method can further include automatically creating designs of the photo products to be placed in the display area in part based on the dimensions of the display area and sizes of the photo products. The designs of the photo products can be automatically created in part based on a color or a texture of the wall. The method can further include automatically selecting photos to be incorporated in the photo products to be placed in the display area. The photos to be incorporated in the photo products can be automatically selected in part based on a color or a texture of the wall. The method can further include storing a layout of the collection of photo products in the display area on the first computer device. The method can further include manufacturing physical photo products based on the collection of photo products to be placed in the display area; and guiding placements of the physical photo products on the wall comprising the steps of: capturing a live image of the display area on the wall using a second computer device; displaying the layout of the collection of photo products in the display area on the second computer device; and placing each of the physical photo products in the display area on the wall based on locations of the respective photo products in the layout. The known dimension can be a width of the anchor, wherein a width of the display area can be automatically calculated using the known dimension of the anchor multiplied by a ratio of a width of the display area to a width of the anchor in the image on the first computer device. The known dimension can be a height of the anchor, wherein a height of the display area can be automatically calculated using the known dimension of the anchor multiplied by a ratio of a height of the display area to a height of the anchor in the image on the first computer device. The first computer device can include a mobile phone, or a tablet computer, or a laptop computer or a desktop equipped with or connected to a camera.

These and other aspects, their implementations and other features are described in detail in the drawings, the description and the claims.

### BRIEF DESCRIPTION OF THE DRAWINGS

FIG. 1 illustrates a conventional web user interface that assists a designer to choose and place photo products on a wall for decoration purpose.

FIG. 2 is a block diagram of a network-based system for producing personalized image products, image designs, or image projects compatible with the present invention.

FIG. 3A is a perspective view illustrating viewing layout and measuring dimensions of a display surface, and choosing and placing photo products using a computer device in accordance with the present invention.

FIG. 3B illustrates a user interface comprising a web browser that allows a user to create and choose personalized photo products, and place these products on the layout of a display surface captured by the computer device in accordance with the present invention.

FIG. 4 is a flowchart for assisting a user to choose and create personalized photo products and place these photo products in correct proportions on a wall for decoration purpose in accordance with the present invention.

### DETAILED DESCRIPTION OF THE INVENTION

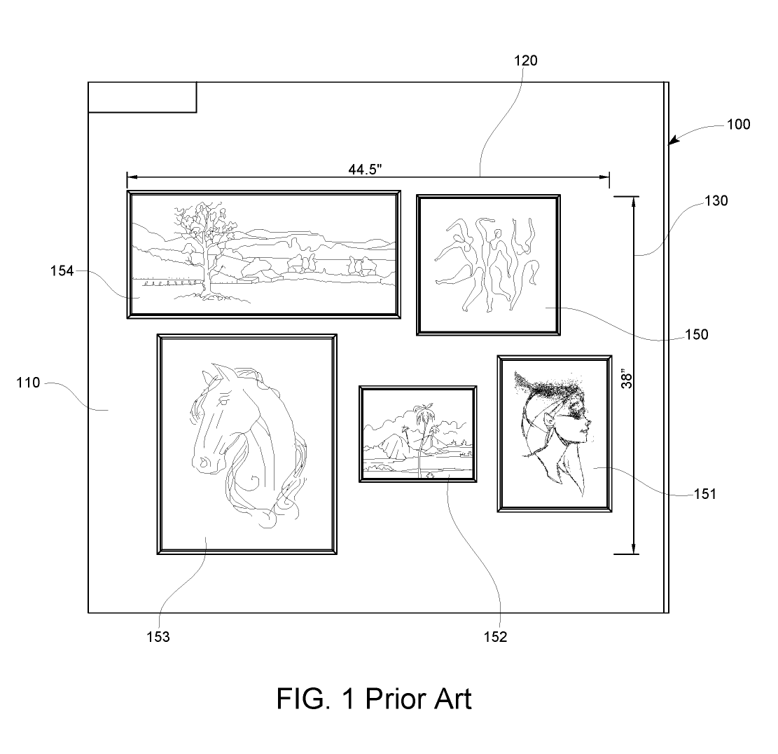

Today, companies like Shutterfly, Inc. provide tools to assist users to create photo products to be displayed on a wall. Users are asked to measure out the dimensions (e.g. 44.5″ by 33″) of the areas. In the product creation path, as shown in FIG. 1, a browser 100 can indicate the width and the height of the display area 110 by lines 120, 130 with end arrows in a blank background, which serves an approximation of the real wall. The user can place photo products 150-154 within the approximate display area 110 indicated by lines 120, 130 and the arrows.

There are several drawbacks associated with the existing tools that assist users to designing a wall with display of photo products. Firstly, users have to make the measurements of the wall themselves. Secondly, the users can only imagine what the final display of the photo products might look like. There is no realistic preview of the photo products in a particular environment.

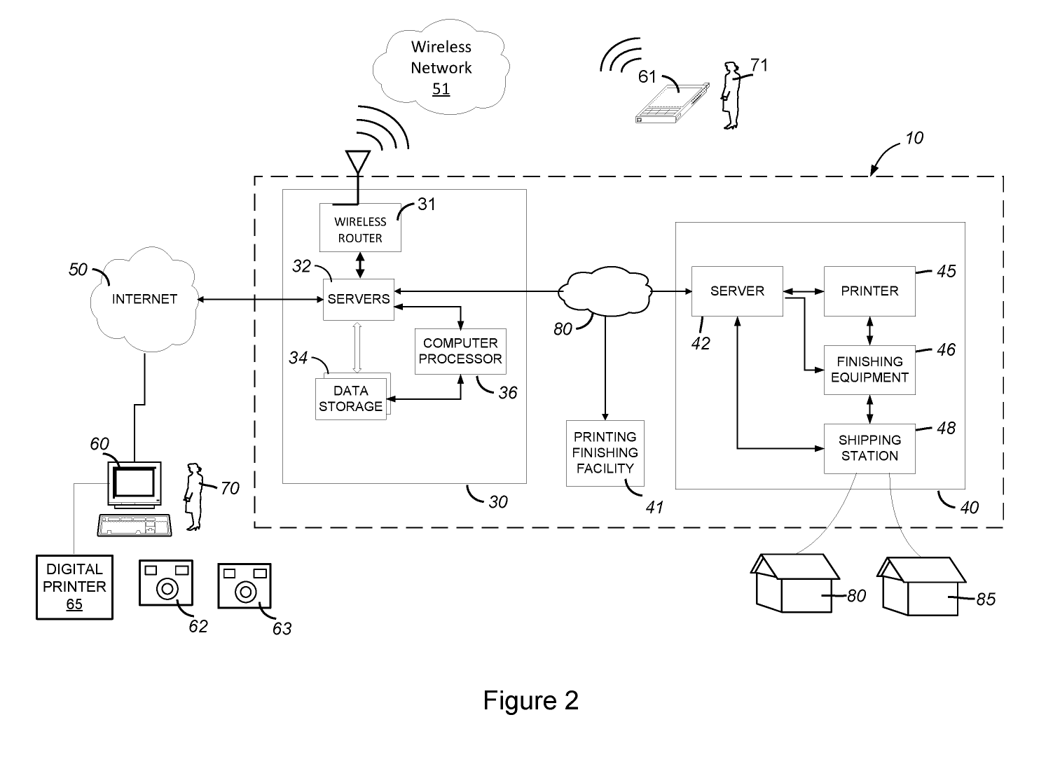

In accordance with the present invention, a system and a method are disclosed to improve user experience, improve dimensional accuracy, and reduce the amount of time for users to design and decorate photo products on a wall. Referring to FIG. 2, a network-based imaging service system 10 enables users 70, 71 to organize and share images via a wired network or a wireless network 51. The network-based imaging service system 10, operated by an image service provider such as Shutterfly, Inc., can fulfill image products ordered by users 70, 71. The network-based imaging service system 10 includes a data center 30, one or more product fulfillment centers 40, 41, and a computer network 80 that facilitates communications between the data center 30 and the product fulfillment centers 40, 41.

The data center 30 includes one or more servers 32 for communicating with devices (60, 61) owned by users 70, 71, a data storage 34 for storing user data, image and design data, and product information, and computer processor(s) 36 for rendering images and product designs, organizing images, and processing orders. The user data includes account information, discount information, and order information associated with the user. A website can be powered by the servers 32 and can be accessed by the user 70 using a computer device 60 via the Internet 50, or by the user 71 using a wireless device 61 via the wireless network 51. The servers 32 can also support a mobile application to be downloaded onto wireless devices 61.

The network-based imaging service system 10 provides tool for users to design and personalize photo products. In the present disclosure, the term “personalized” (or “individualized” or “customized”) refers to content that is specific to the recipient, the user, the gift product, and the occasion, which can include personalized text, personalized images, and personalized designs. Examples of personalized photo or image products may include photobooks, personalized greeting cards, photo stationeries, photo or image prints, photo posters, photo banners, photo playing cards, photo T-shirts, photo mugs, photo aprons, photo magnets, photo mouse pads, a photo phone case, a case for a tablet computer, photo key-chains, photo collectors, photo coasters, photo banners, or other types of photo gift or novelty item. The term photobook generally refers to as bound multi-page product that includes at least one image on a book page. Photobooks can include image albums, scrapbooks, bound photo calendars, or photo snap books, etc. An image product can include a single page or multiple pages. Each page can include one or more images, text, and design elements. Some of the images may be laid out in an image collage. Moreover, a collection personalize photo or image products can be designed in a coherent layout to be displayed on walls for decorations at home or in a business or commercial surrounding.

The user 70 or his/her family often owns multiple cameras 62, 63 including mobile phones with built-in cameras, digital cameras, a video camera, and computers with built-in cameras. The user 70 transfers images from cameras 62, 63 to the computer device 60 (e.g. a personal computer, a laptop, or tablet computer, a mobile phone, etc.) on which the images can be edited and organized.

Images in the cameras 62, 63 are stored on the computer device 60 and the wireless device 61 can be uploaded to the server 32 to allow the user 70 to organize and render images at the website, share the images with others, and design or order image product incorporating the images. The pictures on the wireless device 61 can be uploaded to the data center 30. If users 70, 71 are members of a family or a group (e.g. a soccer team), the images from the cameras 62, 63 and the mobile device 61 can be grouped together to be incorporated into an image product such as a photobook, or used in a blog page for an event such as a soccer game.

The users 70, 71 can order a physical product based on the design of the image product, which can be manufactured by the printing and finishing facilities 40 and 41. A recipient receives the physical product with messages from the users at locations 80, 85. The recipient can also receive a digital version of the design of the image product over the Internet 50 and/or a wireless network 51. For example, the recipient can receive, on her mobile phone, an electronic version of the greeting card signed by handwritten signatures from her family members.

The images or videos stored in the data storage 34, the computer device 60, or the mobile device 61 usually include groups of photos or videos taken at different events and occasions.

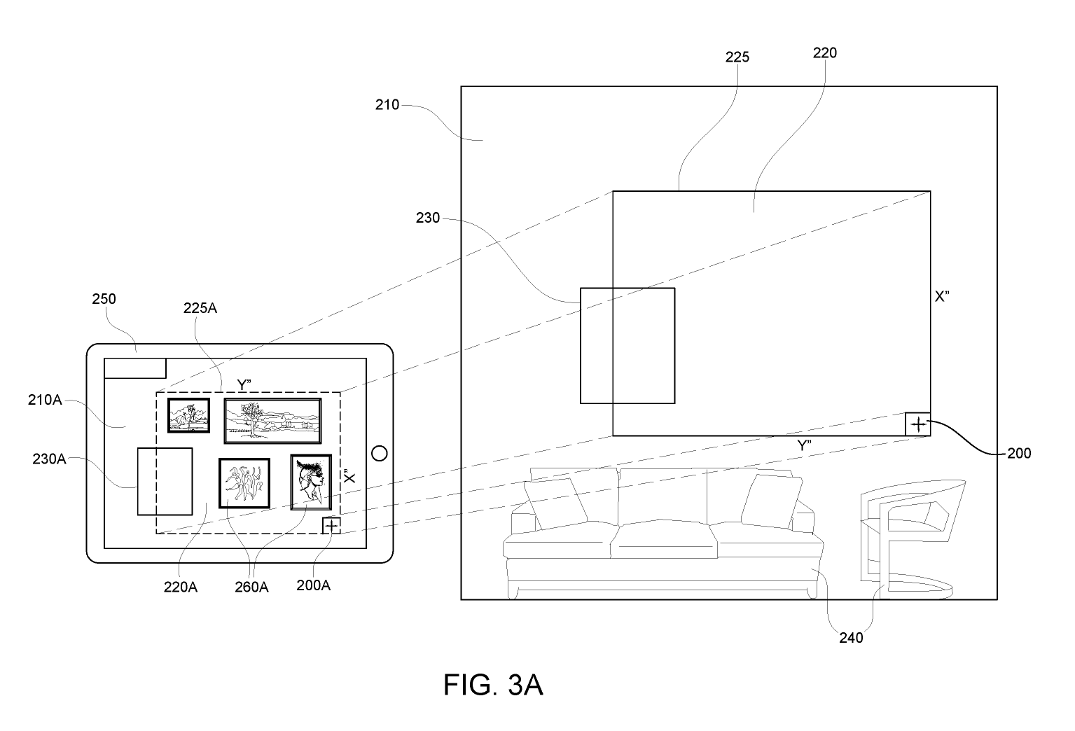

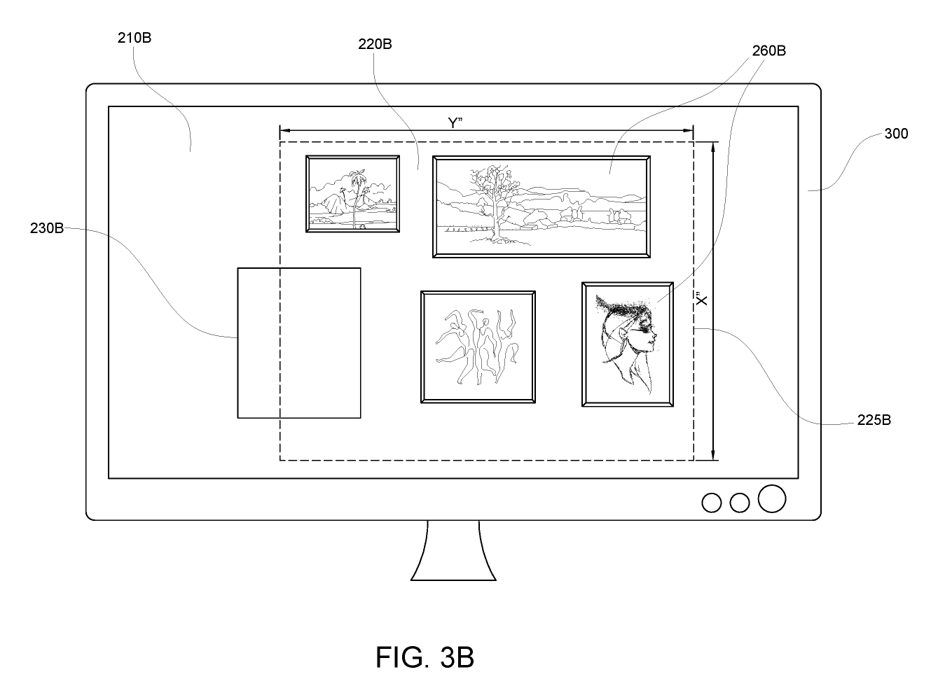

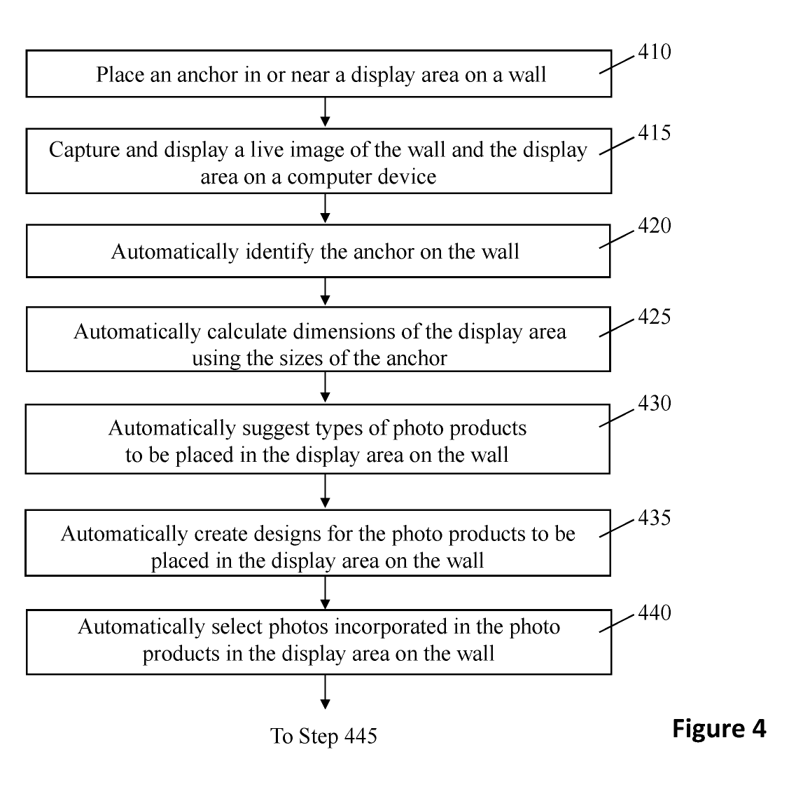

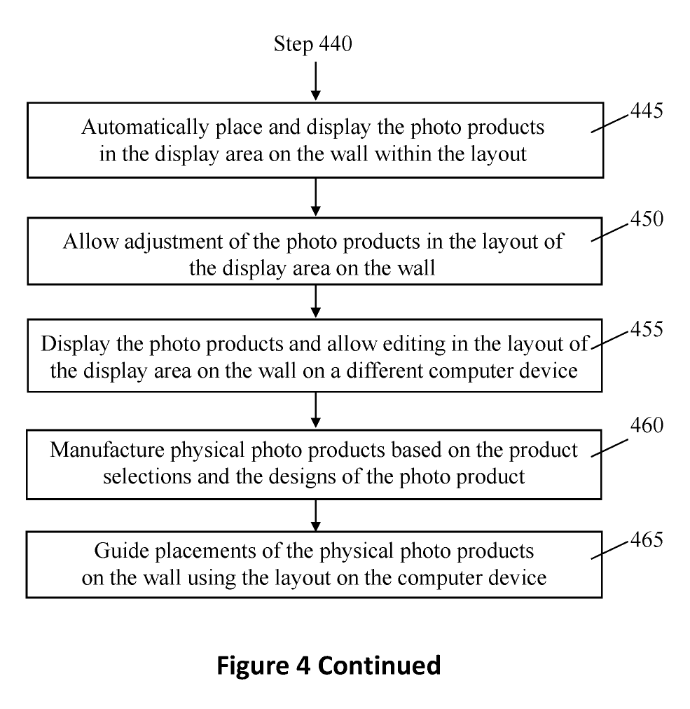

To improve user experience, improve dimensional accuracy, and reduce the amount of time for users to design and decorate photo products on a wall, user 70, 71 can use the wireless device 61 or the computer device 60 installed with a software application provided by the server 32. Referring to FIGS. 3A, 3B, and 4, a user first places an anchor 200 on a wall 210 on which photo products are to be placed or hung for decoration (step 410). The anchor 200 can be placed in or near a display area 220 on the wall 200. The wall 210 can include areas that are not useable by the display area 220 for displaying photo products: for example, objects such as a window 230, a door (not shown), a stair case (not shown), etc. In addition, furniture 240 can also block certain portion the wall 210.

The primary function of the anchor 200 to provide a length scale for the display area 220 and the photo products to be selected to be placed in the display area 220 for decoration. The anchor 200 can be implemented using objects of known fixed dimensions such as a square post-it paper (3″ by 3″), a letter size paper (8.5″×11″), a coin, an electronic device (e.g. an iPhone), a ruler, or a sheet of paper with a ruler (e.g. 4″ long) drawn or printed on it. Depending on the weight and the configuration, the anchor 200 can be attached to the surface of the wall 210 (by adhesive or hanging off a nail) or placed on a shelf or table leaning against the wall 210 with a known fixed dimension of the anchor 200 positioned parallel to the surface of the wall 210.

In some embodiments, the user can receive a physical anchor in mail from an image service provider such as Shutterfly, Inc. The physical anchor can have a self-adhesive backing that allows it to be adhered to the wall surface. The user can also receive, from an image service provider, a digital file of an image of the anchor which can be printed to an absolute scale.

Another function of the anchor 200 is to provide a reference point to define the position of the display area 220 on the wall 210. For example, the anchor 200 can define a corner of the display area 220, which can be used as the origin of an x-y coordinate for the display area 220, as shown in FIG. 3A.

Next, an application is launched, under the command of a user, on a computer device 250 (e.g. the wireless device 61 or the computer device 60 in FIG. 2) which is communication with the server 32 (FIG. 2). The computer device 250 can include a mobile device such as a mobile phone or a tablet computer, as well as a laptop computer or a desktop equipped with or connected to a camera. The computer device 250 can also include wearable computer devices such as Google Glass, HoloLens, and virtual reality devices such as Oculus Rift, etc. which allow users to view and edit digital content superimposed on a real environment.

The application uses the camera function of the computer device 250 to capture a live image of the wall 210 and the display area 220, and display them on the computer device 250 (step 415). The live image can include a video recording, or one or more still images. The application on the computer device 250 can display a virtual border 225A around a display area 220A and an anchor 200A in or near the display area 220A. The virtual border 225A can be adjusted by the user by touching, holding, and moving a border line on a touch sensitive screen. The display area 220A and the anchor 200A on the computer device 250 are respectively projected to the display area 220 and the anchor 200 on the wall 250. Similarly, the virtual border 225A on the computer device 250 corresponds to a virtual border 225 around the display area 220 on the wall 210. Other objects such as a window 230A and furniture can also be displayed on the computer device 250.

The application can automatically search and identify the anchor 200 as the anchor 200A on the screen of the computer device 250 (step 420) and infer its physical dimensions (e.g. the size of an iPhone 6s, or a quarter coin in U.S. currency). The known dimensions of the anchor 200A are pre-stored, and are retrieved by the computer device 250 after the anchor 200 is identified on the wall 210. Alternatively, the application can include a function to allow the user to first identify the anchor 200A (step 420) by touching the anchor 200A on the screen. The computer device 250 includes a computer processor that recognizes the image object selected by the user as the anchor 200A. The computer processor automatically detects the boundaries of the anchor 200A, and calculates its width and height in number of pixels using the positions of the boundaries. Alternatively, the application on the computer device 250 can allow the user to enter the dimension of the anchor 200 (for example, for the case of a ruler), or select from one for the most commonly used object as anchor with standard fixed dimensions (e.g. a post-it, a dollar bill, etc.).

Using the dimensions of the anchor 200, the computer processor automatically calculates the dimensions of the display area 220 (step 425). The calculation involves determining the width and the height of the display area 220A in the number of pixels on the computer device. With the dimension ratio of the display area 220A to the anchor 200A obtained, and the real dimensions of the anchor 200 known, the real dimensions of the display area 220 can be accurately calculated by proportional ratios.

Wd=Wa×(Wd′/Wa′) eqn. (1)

in which Wd′ and Wa′ are respectively the widths (or heights) of the display area 220A and anchor 200A in pixels on the computer device 250; Wd and Wa are respectively the real physical widths (or heights) of the display area 220 and the anchor 200 on the real wall 210.

In some embodiments, the application on the computer device 250 automatically suggests the types of photo products to be used for decoration (step 430), based on the dimensions of the display area 220 as well as the sizes of the photo products, and logics and rules for aesthetic appearances. The types of photo products can include canvas print, posters, framed photo or image prints, self-adhesive photo print boards, calendars, banners, photo accessories, as well as decorative wall paper.

In some embodiments, the application on the computer device 250 or the server 32 (FIG. 2) automatically creates designs for the photo products 260A of the selected photo product types (step 435) based on the dimensions of the display area, the sizes of the photo products, and logics and rules for aesthetic appearances. The design includes the number and types of photo products as well as layouts of the photo products. The logics and rules take into account not only the overall dimensions (e.g. width, height, etc.) of the display area 220, the dimensions of the collection of photo products 260A, but also the gaps between the products and margins along the borders of the display area 210. Furthermore, the application on the computer device 250 or the server 32 (FIG. 2) automatically creates designs for individual photo products, which includes borders, background, design elements, text fonts and colors, and selection of user's photos within individual photo products, which is also in part based on the dimensions of the display area and the sizes of the photo products.

In some embodiments, photos are automatically selected from user's photos on the computer device or in the data storage 34 (FIG. 2) to incorporate in the photo products in the display area on the wall (step 440). The selections of the photos for the photo products are in part based on the dimensions of the display area, the sizes of the photo products, and the types of photo products.

In some embodiments, the selection of photo product types, design of the photo products, and photos incorporated in the photo products can depend on the surface textures, painting as well painting colors of the wall 210 (steps 430 and 435). For example, the computer device 250 or the server 32 (FIG. 2) can calculate the color distributions in the photos, and selecting those photos having color distributions that match the color of the wall 210, or to produce aesthetic contrast against the color of the wall 210.

Optionally, in some embodiments, the application on the computer device 250 allows the user to pick or create a collection of photo products 260 compatible with the display area 220. The user can also edit photos or photo product designs that are automatically created by the application and the computer system.

The collection of photo products 260A can be automatically placed and displayed within the layout of the display area on the computer device 250, based on the logics and rules for aesthetic appearances (step 445). The collection of photo products 260A can also be manually placed based on the wall by the user.

In some embodiments, a plurality of photo product layouts can be stored in a computer storage (e.g. the data storage 34 in FIG. 2 or the computer device 250) for commonly occurring display areas (sizes and aspect ratios). For each of the common display area in size and shape, there can be a plurality of layouts for possible photo products. The computer processor can retrieve these layouts in response to the calculated dimensions and aspect ratio of the display area 220 and automatically selects one or more layouts to recommend to the user (step 445). The library of layouts can also be used for recommending particular photo products to be used in decorating the specific display area 220 (step 430).

One advantageous feature of the disclosed method is that the application on the computer device 250 allows the user to preview how the photo products look like on the computer device 250 in a digital environment that include both virtual objects and representations of physical objects from the real environment. Once the collection of photo products 260A is placed in the display area 220A, the user can preview the appearance of the collection of photo products 260A in the realistic environment (with the correct dimensions, and the objects such as furniture, doors, windows, and staircase, etc.). The user can adjust the position of the collection of photo products 260, change the photos in the collection of photo products 260A, or change the types of the photo products 260A in the layout of the display area 220 on the wall 210 (step 450) to achieve the best decorative appearance. The user can zoom in to look at details of the photo products and zoom out to look at the display effect of the entire surface of the wall 210A in the environment.

Once a satisfactory set of photo products 260A has been selected for the display area 229 on the wall 210, a project can be saved on the computer device 250 and in a networked computer storage over a computer network (e.g. the data storage 34 in FIG. 2). The project can be optionally previewed and edited on different computer devices (step 455) in communication with the networked computer storage. For example, referring to FIG. 3B, the project can be displayed in a web user interface (e.g. a web browser) on a desktop computer 300 in communication with the networked computer storage. The photo products 260B can be displayed in the display area 220B defined by a virtual border 225B on a wall 210B. Window 230B, furniture, door, and staircase can also be displayed on the desktop monitor 300. Since the anchor has fulfilled its roles, it is optional whether an anchor is displayed on the desktop computer 300. The user can adjust the positions and alignments of the collection of photo products 260B, change the pictures in the collection of photo products 260B, or change product types.

Once the project is finalized, the user can order the set of photo products from image-service providers such as Shutterfly, Inc. The photo products are manufactured based on the product selections and the designs of the photo product (step 460). After the user receives the photo products, the user can place the photo products using the layouts on a computer device as guidelines (step 465). This computer device can be the same or a different device (e.g. a different mobile phone) from the one used to create the design of the collection of photo products on the wall. Referring to FIG. 3A, while showing a live picture of the wall 210 and the layout of the collection of photo products 260A on the computer device in the application (operated by a first user), a (second) user can place one of the physical photo product on the wall in such a way such that the outline of the physical photo product coincides with the outlines of photo product 260A in the layout on the computer device 250. Positioning all physical photo products in such a way assures maintaining the aesthetic effect of the photo products as originally designed.

It should be understood that the presently disclosed systems and methods can be compatible with different devices and image products or applications other than the examples described above. The network-based system can be implemented with different hardware or software configurations without deviating from the spirit of the present invention. User behaviors, product types, user categories, and category specifications are not limited to the described examples while still compatible with the disclosed invention.

What is claimed is:

1. A method for automatically creating design for a collection of photo products in a display area, comprising:
capturing an image of a display area and an anchor on a wall by a first computer device, wherein the anchor has a known dimension;
automatically identifying the anchor on the wall;
automatically calculating dimensions of the display area using the known dimension of the anchor and relative dimensions of the display area and the anchor in the image on the first computer device;
automatically suggesting a collection of photo products to be placed in the display area based on the dimensions of the display area and sizes of the photo products; and
displaying the collection of photo products in the display area on the wall on the first computer device.

2. The method of claim 1, wherein the first computer device retrieves the known dimension from a computer storage in response to the step of identifying the anchor on the wall.

3. The method of claim 1, wherein the known dimension of the anchor is received from a user by the first computer device.

4. The method of claim 1, wherein the anchor defines location of the display area on the wall.

5. The method of claim 1, further comprising:
displaying a virtual border around the display area on the first computer device, wherein the collection of photo products is displayed within the virtual border on the first computer device.

6. The method of claim 1, further comprising:
automatically suggesting types for the photo products to be placed in the display area based on the dimensions of the display area and sizes of the photo products.

7. The method of claim 6, wherein the types of the photo products to be placed in the display area are automatically selected in part based on a color or a texture of the wall.

8. The method of claim 1, further comprising:
automatically creating designs of the photo products to be placed in the display area in part based on the dimensions of the display area and sizes of the photo products.

9. The method of claim 8, wherein the designs of the photo products is automatically created in part based on a color or a texture of the wall.

10. The method of claim 1, further comprising:
automatically selecting photos to be incorporated in the photo products to be placed in the display area.

11. The method of claim 10, wherein the photos to be incorporated in the photo products is automatically selected in part based on a color or a texture of the wall.

12. The method of claim 1, further comprising:
storing a layout of the collection of photo products in the display area on the first computer device.

13. The method of claim 12, further comprising:
manufacturing physical photo products based on the collection of photo products to be placed in the display area; and
guiding placements of the physical photo products on the wall comprising the steps of:
capturing a live image of the display area on the wall using a second computer device;
displaying the layout of the collection of photo products in the display area on the second computer device; and
placing each of the physical photo products in the display area on the wall based on locations of the respective photo products in the layout.

14. The method of claim 1, the known dimension is a width of the anchor, wherein a width of the display area is automatically calculated using the known dimension of the anchor multiplied by a ratio of a width of the display area to a width of the anchor in the image on the first computer device.

15. The method of claim 1, wherein the known dimension is a height of the anchor, wherein a height of the display area is automatically calculated using the known dimension of the anchor multiplied by a ratio of a height of the display area to a height of the anchor in the image on the first computer device.

16. The method of claim 1, wherein the first computer device includes a mobile phone, or a tablet computer, or a laptop computer or a desktop equipped with or connected to a camera.
